(19) United States
(12) Patent Application Publication
(10) Pub. No.: US 2003/0122386 A1
(43) Pub. Date: Jul. 3, 2003

(54) Sliding glass door lock

(76) Inventor: Scott L. Lyons, Melbourne, FL (US)

Correspondence Address: John L. DeAngelis, Jr., Esq., Beusse Brownlee Bowdoin & Wolter, P.A., 390 N. Orange Ave, Suite 2500, Orlando, FL, 32801, US

(21) Appl. No.: 10/033,270

(22) Filed: Dec. 27, 2001

(51) Int. Cl. E05C 17/54

(52) U.S. Cl. 292/339

(57) ABSTRACT

A sliding glass door lock includes two telescoping members spanning the distance between the vertical door frame proximate the stationary portion of the door and the proximal vertical surface of the sliding portion of the sliding glass door to restrain the sliding portion from movement within the door rails.

### FIELD OF THE INVENTION

This invention relates to sliding glass doors generally, and more specifically to a telescoping bar for securely locking sliding glass doors in a closed position.

### BACKGROUND OF THE INVENTION

Home security has become an ever-increasing concern in the minds of apartment, home and condominium dwellers. It is imperative that people feel secure within their homes. Sliding glass doors, which are commonly found in modern structures, especially dwellings, impose a particularly vulnerable entry into the home. They are generally located to provide ingress and egress between the dwelling and patio or porch area. Typically, the sliding glass door comprises at least one slidable glass-paned door and a single stationary glass-paned door. In operation, the sliding glass door is opened by urging the slidable door along upper and lower door tracks, mounted in the overhead door transom and the door threshold, until a sufficiently wide opening is created. Usually, the sliding door is opened to the extent where the slidable door is substantially aligned with the stationary door. The resulting opening allows for ingress and egress through the open area.

Various approaches are available for securing the slidable door to prevent entry into the dwelling or structure from the outside. For example, a rod or bar can be placed within the lower track to prevent movement of the slidable door. Conventional hook-type locks can also be utilized to secure the slidable door to the door jamb, to prevent sliding movement of the slidable door. However, such devices do not always function as intended. For example, an especially vigilant intruder may be able to pry the slidable door upwardly from its tracks and thereby avoid the locking feature provided by the placement of a rod in the track. Certain door jamb locks can be disengaged from the outside by accessing the locking mechanism through a hole cut into the outside door frame or simply by wedging the door against the jamb.

### BRIEF SUMMARY OF THE INVENTION

The present invention is a sliding glass door lock comprising telescoping bar members removably attached to the door jamb frame and the facing side surface of the slidable door. Because the bar members are telescopable, the lock according to the present invention is adjustable to fit within the opening between the door jamb frame and the facing edge of the sliding glass door. Thus various size doors can be easily accommodated without the requirement for time consuming and mechanically difficult length adjustments of a locking bar, as is the case for a bar placed within the threshold track.

### BRIEF DESCRIPTION OF THE DRAWINGS

The forgoing and other features of the invention will be apparent from the following detailed description of the invention, as illustrated in the accompanying drawings in which like reference characters refer to the same parts through out the different figures. The drawings are not necessarily to scale, emphasizes instead being placed upon illustrating the principles of the invention.

FIG. 1 illustrates a sliding glass door including a locking apparatus constructed according to the teachings of the present invention;

FIG. 2 is a perspective illustration of the locking apparatus according to the present invention;

FIGS. 3 through 9 illustrate various elements of the locking apparatus of FIG. 2; and

FIG. 10 illustrates a second embodiment for securing the locking apparatus of FIG. 2.

### DETAILED DESCRIPTION OF THE INVENTION

Before describing in detail the particular sliding glass door lock in accordance with the present invention, it should be observed that the present invention resides primarily in a novel and non-obvious combination of hardware elements. Accordingly, the hardware components have been represented by conventional elements in the drawings, showing only those specific details that are pertinent to the present invention so its not to obscure the disclose with structural details that will be readily apparent to those skilled in the art having the benefit of the description herein.

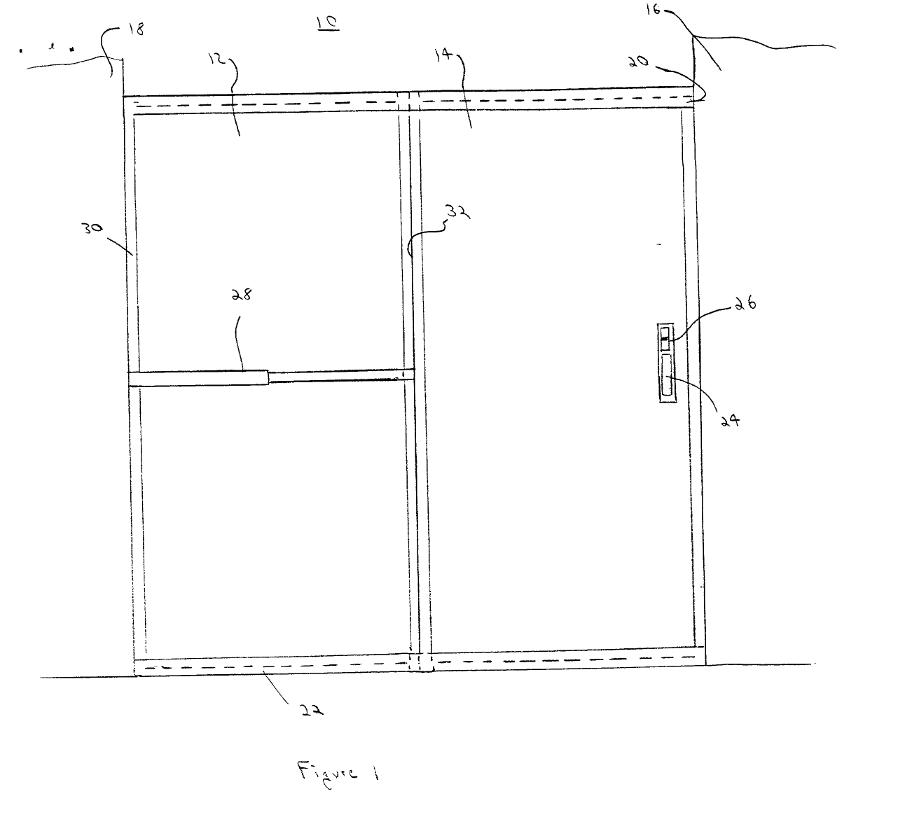

FIG. 1 illustrates a sliding glass door 10 comprising a stationary pane 12 and a sliding door 14. The sliding glass door 10 is mounted in a door jamb frame (not shown) between wall segments 16 and 18. The sliding door 14 is slideably engaged in upper and lower rails 20 and 22, respectively. When viewed from inside the structure, the vertical plane of the sliding door 14 is in front of the vertical plane of the stationary pane 12. To fully open the sliding glass door 10, the sliding door 14 is moved transversely within the rails 20 and 22 such that the sliding door 14 is positioned in front of the stationary pane 12. In FIG. 1, the sliding glass door 10 is shown in a closed position.

The sliding door 14 also includes a conventional recessed finger pull 24 and any one of many different jamb-type locking mechanisms, represented generally by a reference character 26. A locking bar 28, constructed according to the teachings of the present invention, is shown installed between a door jamb 30 mounted to the wall segment 18 and a vertical surface 32 of the sliding door 14. Generally, the vertical surface 32 comprises a portion of the frame of the sliding door 14. Although the locking bar 28 is shown about midway along the vertical dimension of the sliding door 14, the locking bar 28 can be placed at any desired height above the rail 22.

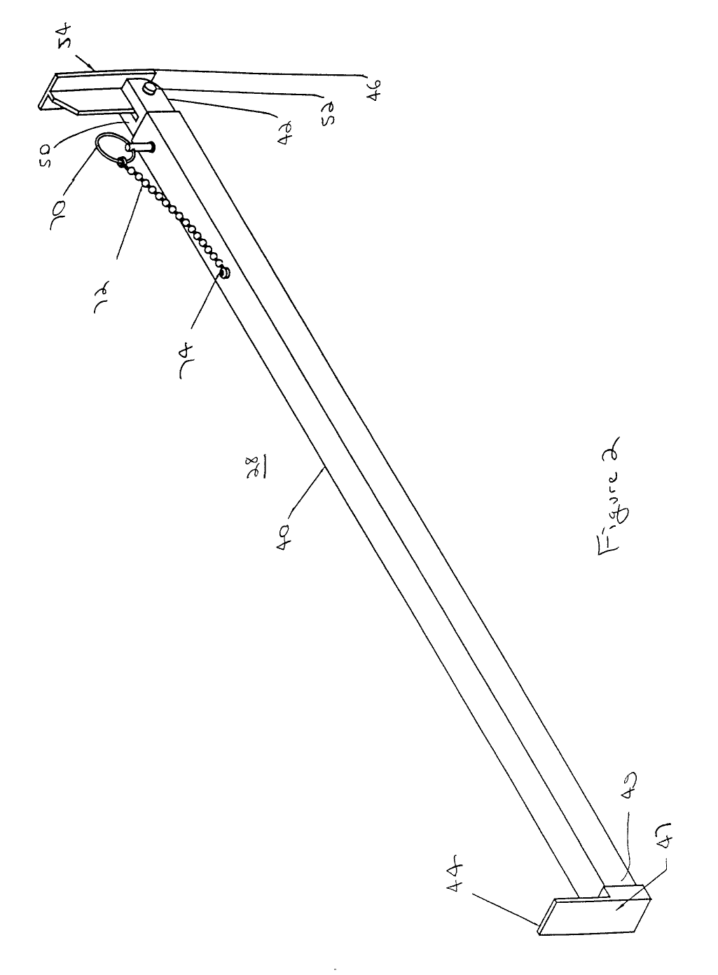

FIG. 2 is a perspective view of the locking bar 28, including a telescoping tube 40 for receiving a pivot bar 42, sized to fit within the interior volume of the telescoping tube 40. FIG. 2 also illustrates the mounting components for the locking bar 28, including a cradle 44 and a jamb-mounted bracket 46.

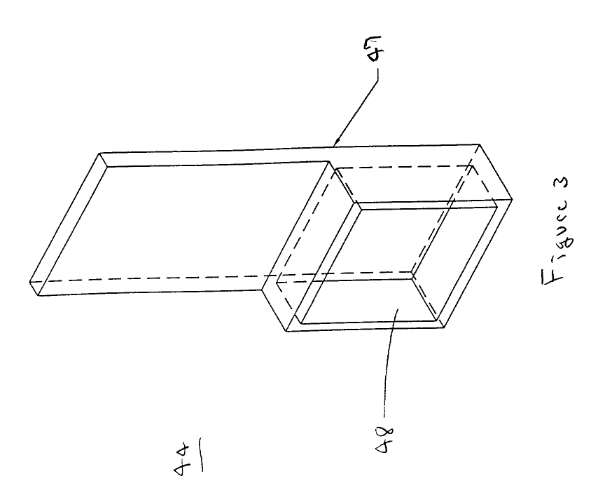

The cradle 44 is removably affixed to the surface 32 by, for example, a hook and loop material, such as Velcro® material. One of the hook and loop mating surfaces is affixed to a rear surface 47 of the cradle 44, and the other mating surface is affixed to the surface 32 of the of the sliding door 14. The cradle 44 is further illustrated in FIG. 3, showing a receiving portion 48 for receiving an end 49 (see FIG. 1) of the telescoping tube 40.

Returning to FIG. 2, an end 50 of the pivot bar 42 is pivotally attached to the jamb mounting bracket 46 by a pin 52 extending through aligned holes within the pivot bar 42 and the jamb mounting bracket 46. The jamb mounting bracket 46 is removably affixed to the inside surface of the door jamb 30, by, for example, a hook and loop material, such as Velcro® material. One of the hook and loop mating surfaces is affixed to a rear surface 54 of the jamb mounting bracket 46, and the other mating surface is affixed to the inside surface of the door jamb 30.

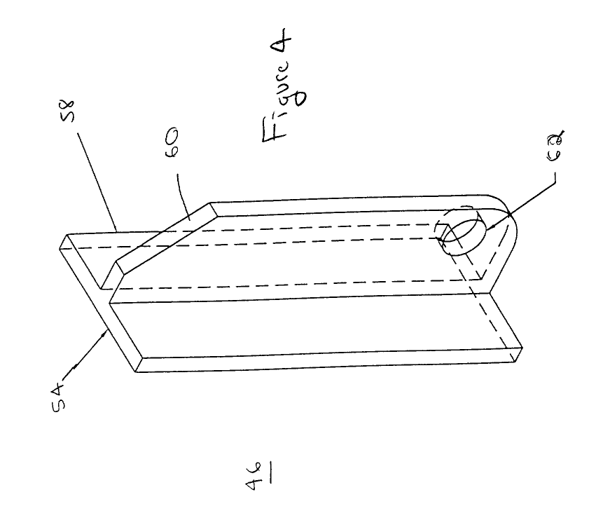

FIG. 4 shows additional details of the jamb mounting bracket 46 including a base 58 and an attached plate 60 oriented perpendicular to the base 58. The pin 52 of FIG. 2 passes through a hole 62 for pivotally securing the pivot bar 42 to the jamb mounting bracket 46.

Since both the cradle 44 and the jamb mounting bracket 46 are demountably attached to their respective mounting surfaces using a hook and loop material, each can be removed by the occupant as desired. For instance, if the occupant moves to another dwelling, the locking bar 28 is removable from the sliding glass door frame for reuse with a sliding glass door at the new home. As will be discussed below, the length of the locking bar 28 is extensible to accommodate any sliding glass door size.

Returning to FIG. 2, there is illustrated a pin 70 for engaging and locking the telescoping tube 40 with respect to the pivot bar 42. To lock the sliding glass door 10, the locking bar 28 is placed between the door jamb 30 and the surface 32, such that the hook and loop material on the rear surface 47 and 54 of the cradle 44 and the jamb mounting bracket 46, respectively, mates with the complementary material on the door jamb 30 and the surface 32. The telescoping bar 40 is then extended from the pivot bar 42 until the end 49 is received within the receiving portion 48 of the cradle 44. At least one of several holes in the telescoping bar 40 will be aligned with one or more holes in the pivot bar 42 (to be described in detail below) and the pin 70 is then fitted within the aligned holes to secure the telescoping bar 40 with respect to the pivot bar 42. In one embodiment, the pin 70 is secured to the telescoping bar 40 by a chain 72 attached at one end to the pin 70 and at the other to a screw 74 (or other hardware fixture) attached to the telescoping bar 40.

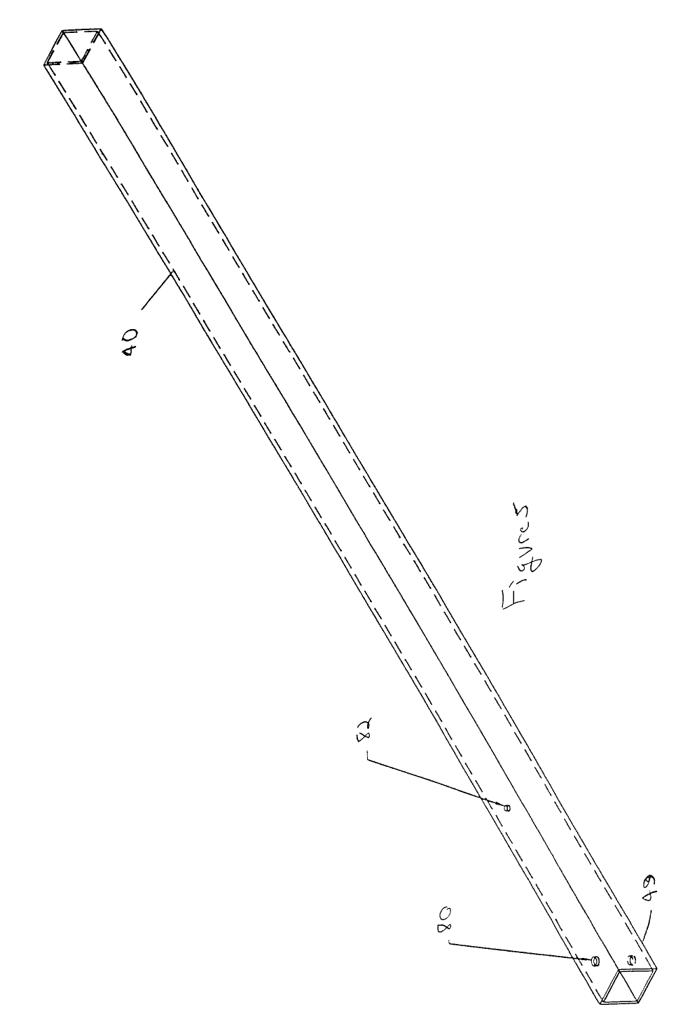

FIG. 5 illustrates the telescoping bar 40 including a hole 80 for receiving the pin 70. In another embodiment the telescoping bar 40 includes a plurality of holes 80 for mating with a hole in the pivot bar 42 to provide additional adjustability for the length of the locking bar 28. A hole 82 receives the screw 74. In one embodiment, when the telescoping bar 40 and the pivot bar 42 are fully engaged, the locking bar 28 is about 30 inches long. The pivot bar 42 is about 27 inches long and the telescoping bar is about 28 inches long. Thus the locking bar 28 can be extended, by telescoping the telescoping bar 40 and the pivot bar 42, to at least about four feet to accommodate conventional sliding glass door dimensions, such as the sliding glass door 10 shown in FIG. 1. Also, the telescoping bar 40 and the pivot bar 42 can be constructed with lengths beyond the dimensions given above to accommodate wider sliding glass doors. The locking bar 28 can also be used with triple sliding glass, having one stationary pane and two sliding doors, where the first door slides toward the second door and then both together slide toward the stationary pane. In this application the locking bar 28 is placed between the door jamb adjacent the stationary pane and the edge of the first door. Since the first door is restrained by the locking bar 28, the first door cannot move toward the second door, and thus the first and the second doors together cannot slide toward the stationary pane.

Also, two locking bars 28 with the dimensions given above can be placed end-to-end to span a longer distance than one bar can span alone. In another embodiment, the locking bar comprises a plurality of segments, nested such that one telescopes within the next adjacent member, such that longer distances can be spanned. The plurality of segments are locked in place against further slidable movement according to the pin or leaf spring locking mechanism described herein, or any other mechanism that prevents slidable movement of the segments.

Although the telescoping bar 40 and the pivot bar 42 are illustrated in FIG. 5 with a rectangular or square cross section, this is not required. In another embodiment, the telescoping bar 40 and the pivot bar 42 can be formed from with a circular cross-section.

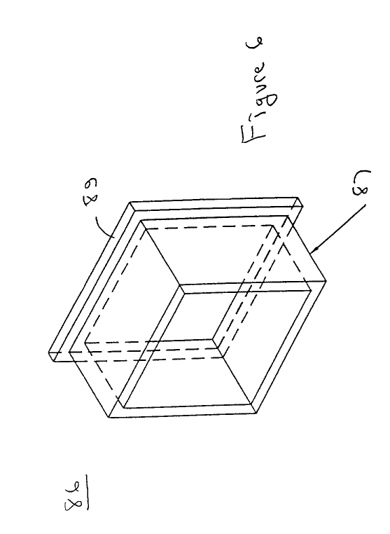

In yet another embodiment, an end cap 86, illustrated in FIG. 6, includes a receiving portion 87, which is demountably attached to the end 49 of the telescoping bar 40, and a back plate 89. In this embodiment, the end cap 86 fits within the receiving portion 48 of the cradle 44.

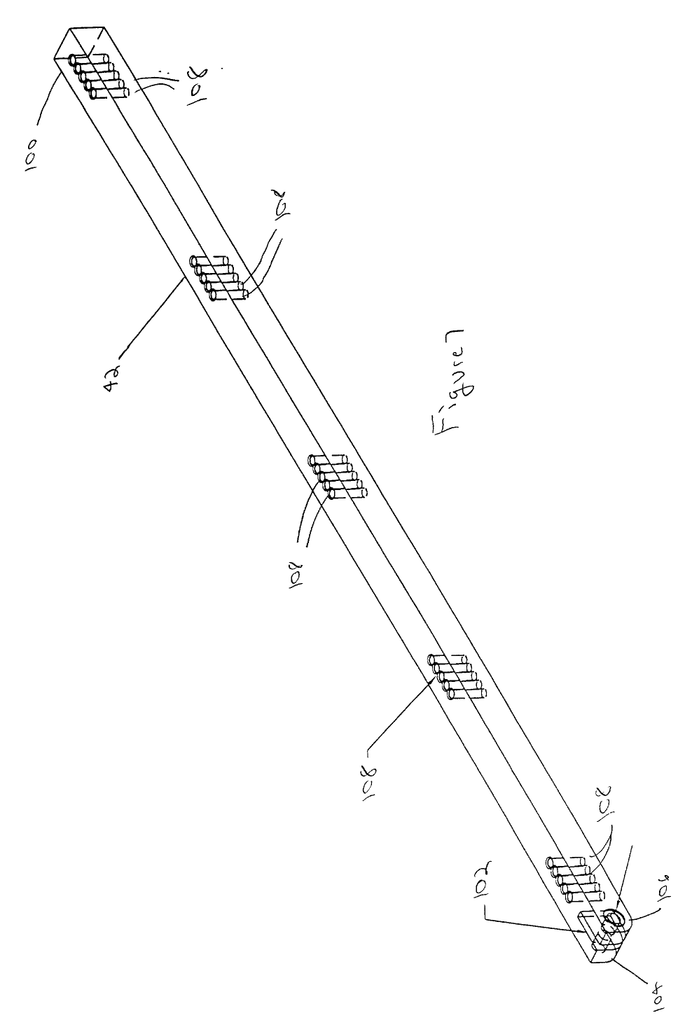

FIG. 7 illustrates a perspective view of the pivot bar 42. An end 100 is received within the telescoping bar 40 as described above. An end 102 is formed in a shape of a shackle having dual U-shaped members 104 and 106. A hole 107 extends through both the members 104 and 106 and is aligned with the hole 62 of the jamb mounting bracket 46. A pin 52 (see FIG. 2) passes through the hole 107 and the hole 62 for pivotally securing the pivot bar 42 to the jamb mounting bracket 46. FIG. 7 illustrates a plurality of holes 108 in the pivot bar 42. Although shown in clusters in FIG. 7, in another embodiment the holes 108 can be spaced apart along the pivot bar 42 at equal or variable distances. One of the holes 108 mates with the hole 80 in the telescoping bar 40 (see FIG. 5) to lock the telescoping bar 40 and the pivot bar 42 at a length that spans the distance between the surface 32 and the door jamb 30 to lock the locking bar 28 in place as shown in FIG. 1.

In use, the cradle 44 and the jamb mounting bracket 42, with the locking bar pivotally attached thereto with the pin 52, are demountably affixed to the surface 32 and the door jamb 30, respectively. The telescoping bar 40 is extended to engage the receiving portion 48 of the cradle 44, and then the telescoping bar 40 and the pivot bar 42 are locked in place with the pin 70. To disengage the locking bar 28, the pin 70 is removed, allowing the telescoping bar 40 to be withdrawn from the receiving portion 48 and then the locking bar 28 is pivoted either upwardly or, more likely downwardly, to rest in a vertical position adjacent the door jamb 30.

The locking bar 28 can also be used to prevent an intruder from opening the sliding glass door 10 beyond an ajar position. In this application, the sliding glass door is opened to the desired distance, then the locking bar placed between the surface 32 and the door jamb 30 such that the pivot bar 42 and the telescoping bar 40 are locked in place. The sliding glass door 10 cannot be opened further due to the force exerted between the door jamb 30 and the surface 32 by the locking bar 28.

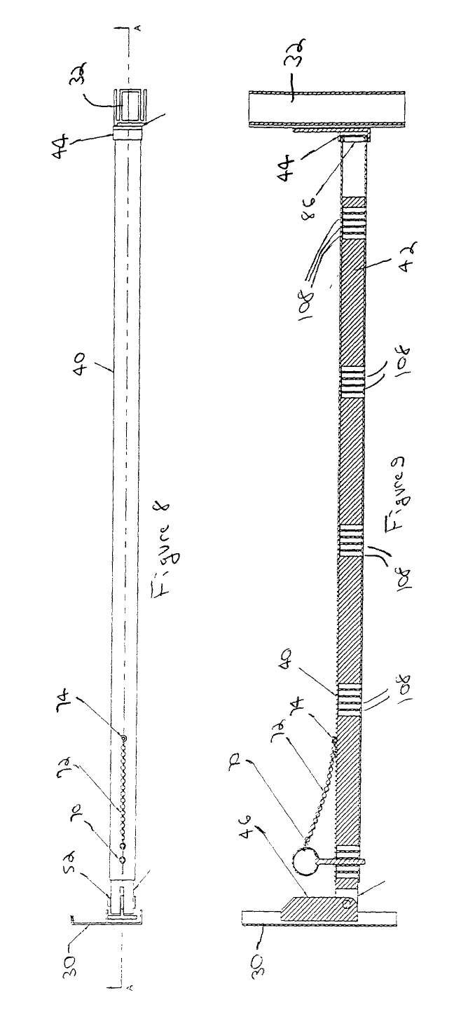

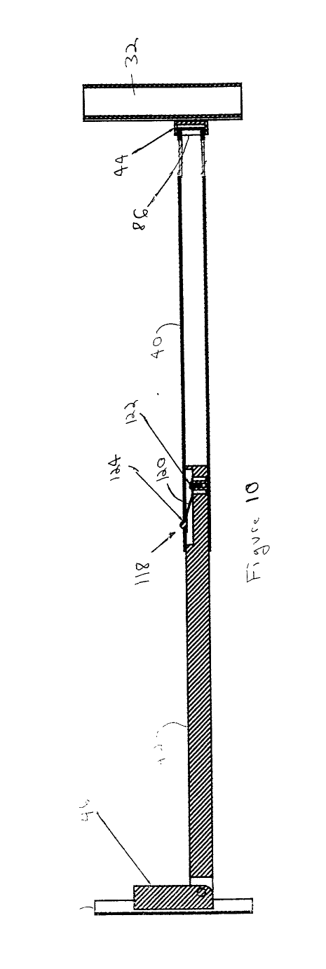

FIGS. 8 and 9 are two additional illustrations of the locking bar 28, showing the elements previously discussed. FIG. 9 is a cross-sectional view along line AA of FIG. 8.

Another apparatus for securing the telescoping bar 40 and the pivot bar 42 in place after mounting between the door jamb 30 and the surface 32 is illustrated in FIG. 10. This apparatus includes the use of a spring lock 118 including a leaf spring 120 securely attached to a fastening device 122, which in turn is attached to the inside surface of the pivot tube 42. A free end of the leaf spring 120 includes a hemispherical locking member 124 that is urged upwardly by action of the leaf spring, into one of a plurality of holes in the telescoping tube 40.

The telescoping and locking features of the locking bar 28 allow use on sliding glass doors of various lengths. It is only required that as the telescoping bar 40 telescopes from the pivot bar 42 to span the distance between the door jamb 30 and the surface 32, that the hole 80 align with one of the holes 108 so that the pivot bar 42 and the telescoping bar 30 can be locked in place, as illustrated in FIG. 1. The use of hook and loop type attachments for both the jamb mounting bracket 46 and the cradle 44 offers an easy installation process for the user.

While the invention has been described with reference to a preferred embodiment, it will be understood by those skilled in the art that various changes may be made and equivalent elements may be substituted for the elements thereof without departing from the scope of the invention. In addition, modifications may be made to adapt a particular situation more material to the teachings of the invention without departing from the essential scope thereof. Therefore, it is intended that the invention not be limited to the particular embodiment disclosed as the best node contemplated to carry out this invention, but the invention will include all embodiments falling within the scope of the appended claims.

What is claimed is:

1. A locking apparatus for use in a structure having a wall with a passageway therethrough, and a sliding glass door covering the passageway, wherein the sliding glass door is framed by first and second opposing vertical side rails proximate upper and lower horizontal rails, and wherein the sliding glass door comprises a stationary portion and a sliding portion, and wherein the sliding portion is slidable within the upper and lower rails for selectively opening and closing the passageway, said locking apparatus comprising:
a mounting member affixed to the vertical side frame member adjacent the stationary pane;
a rigid telescoping member having a first end affixed to said mounting member and a second end abutting the proximal vertical edge of the sliding portion, wherein said rigid telescoping member spans the distance between said mounting member and the proximal vertical edge of the sliding portion, restraining the sliding portion in the closed position.

2. The locking apparatus of claim 1 wherein the telescoping member is pivotally affixed to the mounting member.

3. The locking apparatus of claim 2 wherein the first end of the telescoping member terminates in a U-shaped shackle structure comprising opposing first and second leg members and a hole passing through both of said first and second leg members, and wherein the mounting member comprises a base affixed to the vertical side frame member and a plate member extending perpendicular thereto and further having a hole passing through said plate member, and wherein the locking apparatus further comprises a pin passing through the holes within the leg members and the hole within said plate member for pivotally affixing the telescoping member to the mounting member for pivotal movement of the telescoping member about the axis defined by said pin.

4. The locking apparatus of claim 1 wherein the telescoping member comprises a first tube received within a second tube such that said second tube is slidable with respect to said first tube to span the distance between the mounting member and the proximal vertical edge of the sliding portion, and farther comprising a locking member to lock said first and said second members in place with respect to each other.

5. The locking apparatus of claim 4 wherein the first and the second tubes have holes formed therein, and wherein the locking member comprises a pin for insertion into aligned holes of the first and the second tube.

6. The locking apparatus of claim 1 wherein the mounting member is removably affixed to the vertical side frame member.

7. The locking apparatus of claim 1 wherein the mounting member is removably affixed to the vertical side frame member by the engagement of hook and loop fastening materials, wherein one of the hook and the loop materials is affixed to the mounting member and the other of the hook and the loop materials is affixed to the vertical side frame member.

8. The locking apparatus of claim 1 further comprising a cradle removably affixed to the proximal vertical edge of the sliding portion for receiving the second end of the telescoping member.

9. The locking apparatus of claim 8 wherein the cradle is removably affixed to the proximal vertical edge of the sliding portion by the engagement of hook and loop fastening materials, wherein one of the hook and the loop materials is affixed to the cradle and the other of the hook and the loop materials is affixed to the proximal vertical edge of the sliding portion.

10. The locking apparatus of claim 8 wherein the telescoping member further comprises an end cap affixed to the second end of the telescoping member for engagement with the cradle.

11. The locking apparatus of claim 1 wherein the telescoping member comprises a first tube slidably received within a second tube, and further comprises a locking mechanism for locking said first and said second tubes at the length required to span the distance between the mounting member and the proximal vertical edge of the sliding portion, such that the sliding portion is restrained from slidable movement within the upper and lower rails.

12. The locking apparatus of claim 11 wherein the first and the second tubes include a plurality of holes therein, and wherein the locking mechanism comprises a pin engaging aligned holes of the first and the second tubes.

13. The locking apparatus of claim 11 wherein the second tube includes a plurality of holes, and wherein the locking mechanism is located within the interior of the first tube and comprises an interiorly-located spring biased member protruding beyond the exterior surface of the first tube for engaging one of the plurality of holes within the second tube to lock the second tube in place with respect to the first tube.

14. The locking apparatus of claim 11 wherein the first tube includes a plurality of holes therein, and wherein the second tube includes a hole therein, and wherein the locking mechanism comprises a pin engaging aligned holes of the first and the second tubes.

15. The locking apparatus of claim 1 wherein the rigid telescoping member comprises a plurality of nested telescoping tubular segments, wherein each tubular segment is slidable with respect to the adjacent tubular segment, and further comprising a locking mechanism for locking said tubular segments against further slidable movement when the telescoping member is extended to the length to span the distance between the mounting member and the proximal vertical edge of the sliding portion.
